(19) United States
(12) Patent Application Publication
(10) Pub. No.: US 2018/0061044 A1
(43) Pub. Date: Mar. 1, 2018

(54) Method and System for Monitoring a User to Prevent Pressure Ulcers

(71) Applicants: Jonathan Woodbridge, Corte Madera, CA (US); Tu-Thach Quach, Albuquerque, NM (US)

(72) Inventors: Jonathan Woodbridge, Corte Madera, CA (US); Tu-Thach Quach, Albuquerque, NM (US)

(21) Appl. No.: 15/249,425

(22) Filed: Aug. 28, 2016

(51) Int. Cl. G06T 7/00; G08B 21/02

(52) U.S. Cl. CPC G06T 7/0012; G06T 7/0042; G08B 21/02; G06T 2207/30196; G06T 2207/10048; G06T 2207/30092; G06T 2207/10016

(57) ABSTRACT

The present invention relates to the monitoring of users to prevent pressure ulcers using imaging technologies to detect a user's posture, track the user's poses, detect changes in a user's posture, quantify changes in a user's posture, determine pressure areas from the user's poses, and alert caregivers when a user's current positioning and/or lack of movement may result in the formation of a pressure ulcer. The invention relates to the use of devices that can form images in low to high lighting conditions for monitoring a user to prevent pressure ulcers. These devices include, but are not limited to, thermographic cameras (also known as infrared cameras and thermal imaging camera), image intensifiers (also known as image intensifier tubes), and active illumination. The invention relates to both the hardware used to monitor users to prevent pressure ulcers as well as the algorithms and analytics used to detect a user's posture, detect changes to a user's posture, quantify changes in a user's posture, track the user's poses, determine pressure areas from the poses, as well as detect conditions that may lead to a pressure ulcer. The invention can be used in a variety of environments including, but not limited to, a hospital setting, home setting, and public settings (such as an airplane).

### 1 BACKGROUND OF THE INVENTION

### 1.1 Field of the Invention

The present invention relates to the monitoring of a user to prevent the formation of pressure ulcers. This invention is applied to a user that is sitting, reclining, or laying horizontally.

### 1.2 Description of Related Art

Pressure ulcers result from prolonged pressure to areas of the body. This pressure reduces the amount of blood flow killing the skin in that area. Pressure ulcers are often formed in wheelchairs and beds where a person remains stationary for long periods of time. There are several methods for preventing pressure ulcers such as eating a well balanced diet, drinking plenty of water, and periodically changing the person's position (such as every two hours). This invention, as well as several related art are developed to specifically help with the periodic changing of a person's position.

Several inventions monitor the patient by using sensors mounted to the supporting structure. For example, patent US 20120277637 uses a bed sheet consisting of a grid of pressure sensors. These pressure sensors create a pressure map that can be used to determine a users position and measure the length of time that a user lay stationary. Patent US 20120323501 is a similar patent and pertains to the implementation of a fabric based sensors that creates a bed sheet.

U.S. Pat. No. 8,672,842 is similar to the previous two patents except that pressure sensors are placed within the mattress.

Patent WO 2013016132 places pressure sensors at areas of high risk. These sensors talk to a central control that can automatically adjust one or more areas of a sport structure to minimize risk of a bed sore. U.S. Pat. No. 8,752,222 offers a similar invention that applies to both sitting and lying down.

U.S. Pat. No. 8,675,059 uses a standard video recording to monitor a patient. A pixel by pixel comparison is used to detect changes in posture. The invention proposed in this patent does not use standard video recording and instead uses devices that can form images in low to high lighting conditions that include, but are not limited to, thermographic cameras (also known as infrared cameras and thermal imaging camera), image intensifiers (also known as image intensifier tubes), and active illumination. These devices are used to create a more detailed model of a user than can be done with a standard video recording. In addition, these devices can be used in low to no lighting conditions.

U.S. Pat. No. 9,041,810 B2 uses video recording to detect patient falls in their room. A software module is used to analyze video frames to detect if a patient falls.

### 1.3 SUMMARY OF THE INVENTION

The method of monitoring users to prevent pressure ulcers using imaging technologies to detect a user's posture, track the user's poses, detect changes in a user's posture, quantify changes in a user's posture, determine pressure areas from the user's poses, and alert caregivers when a user's current positioning and/or lack of movement may result in the formation of a pressure ulcer is an improvement. The invention uses devices that can form images in low to high lighting conditions including, but are not limited to, thermographic cameras (also known as infrared cameras and thermal imaging camera), image intensifiers (also known as image intensifier tubes), and active illumination. The invention can track a users pose and positioning using both a hardware device that forms images and a software component that can model the users pose and positioning. The invention will create alerts when users who show behavior that can lead to pressure ulcers, such as remaining in the same position for a long period of time. Model parameters are adjustable by care providers to customize performance for a user.

### 1.4 BRIEF DESCRIPTION OF THE DRAWINGS

FIG. 1 is a graphical illustration of an example deployment of the invention. In this example, the sensing device is mounted to the ceiling and observing the user lying horizontally on a surface.

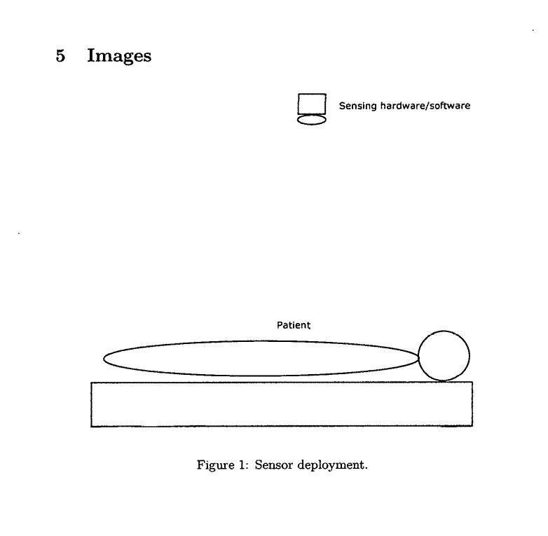

FIG. 2 is a graphical illustration of an example alerting mechanism. In this example, a user has remained in a constant position (or pose) for a prolonged period of time. If the user remains in this position for a time equal to, or greater than the configurable threshold, an alert will be sent to the caregiver.

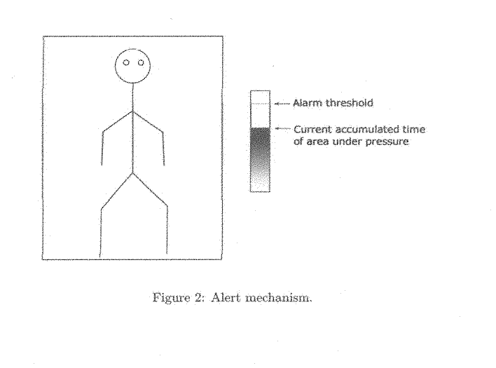

FIG. 3 is a graphical illustration of a user lying on their back. In this example, the invention can classify the users pose as lying on their back as well as the positioning of the users limbs and potential areas of pressure ulcers.

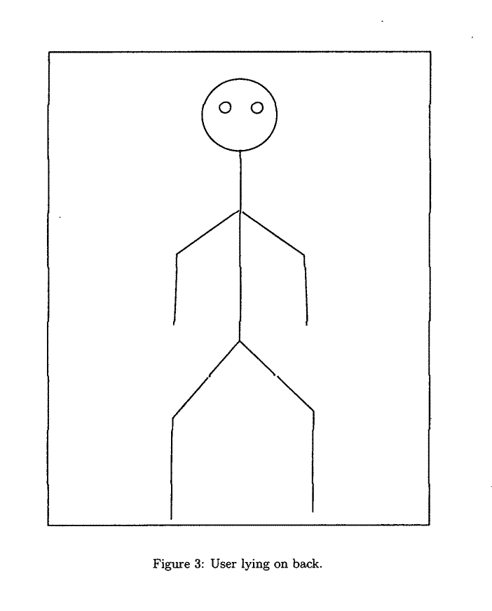

FIG. 4 is a graphical illustration of a user lying on their right side. In this example, the invention can classify the users pose as lying on their right side as well as the positioning of the users limbs and potential areas of pressure ulcers.

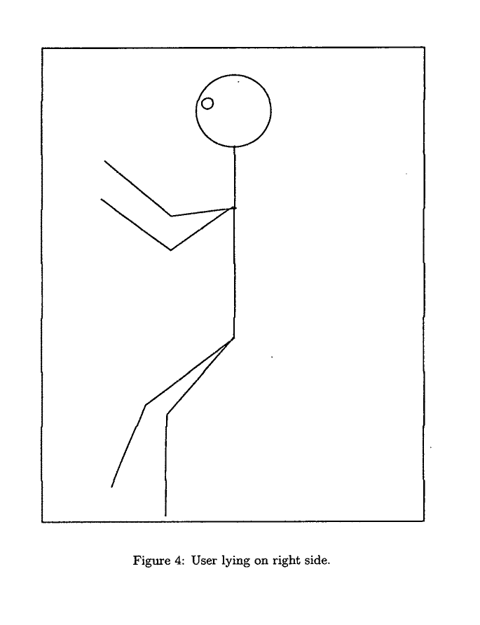

### 2 DESCRIPTION

The invention involves three main components. The first component is a an sensing device module that can form images in low to high lighting conditions including, but not limited to, thermographic cameras (also known as infrared cameras and thermal imaging camera), image intensifiers (also known as image intensifier tubes), and active illumination. This module is responsible for capturing images of a user. The image capture can be continuous or snapshots taken at regular intervals. These images are sent to the second module composed of software that performs analysis including, but not limited to, determine a user's pose and the corresponding pressure areas. The determined pose and pressure areas are sent to the third module composed of software that performs analysis including, but not limited to, quantify changes in a user's posture, track the poses, track the pressure areas, as well as store info, schedules, and other patient information. If the module determines that the user is at risk for pressure ulcers from prolonged inactivity, the module will trigger an alert that can be sent to a health care provide. In addition, the risk determination module has the ability to store images of the poses triggered by pose changes or on fixed time intervals. The images are readily blurred so as to preserve patient privacy.

### 2.1 Sensing Device Module

The sensing device module is composed of a device that can form images in low to high lighting conditions including, but not limited to, thermographic cameras (also known as infrared cameras and thermal imaging camera), image intensifiers (also known as image intensifier tubes), and active illumination. This sensing device may be mounted to a fixed structure (including, but not limited to a wall, ceiling) or a supporting structure (including, but not limited to, a bed, chair, or wheelchair).

The device can be configured manually or automatically. Configurations include, but not limited to, the physical pointing direction, sensitivity of the sensing device, pointing angle, and zoom level. The sensing device module may contain a motorized or manual adjustments to align the sensing device to the user.

The sensing device module can be configured to apply a varying amount of distortion to images to reduce the identifiability of a patient. The amount of distortion may be configurable by a caregiver.

### 2.2 Pose Recognition Module

The second module of the invention is the software analysis module that processes input images provided by the imaging module to determine, but not limited to, the user's pose and the corresponding areas under pressure.

The images from the imaging module are used by the pose classification module to determine the user's pose. The classifier is trained on ground-truth images of users in various poses. Once trained, the classifier can determine the correct pose of the user. In addition, the classifier also identifies the corresponding pressure areas from the pose. In an embodiment, the classifier can be a deep convolutional network.

### 2.3 Risk Determination Module

The third module of the invention is the software analysis module that uses the determined pose and pressure areas from the pose recognition module to perform analysis including, but not limited to, quantify changes in a user's posture, track the poses, track the pressure areas, as well as store info, schedules, and other patient information. If the module determines that the user is at risk for pressure ulcers from prolonged inactivity, the module will trigger an alert that can be sent to a health care provide.

The module keeps track of important statistics for the areas under pressure as identified by the detected poses over a time window. These statistics include, but not limited to, total time each area is under pressure over a time window. From these statistics, the software can generate an alarm if any area is under pressure longer than a specified duration. The software is flexible so that the duration threshold can vary across pressure areas. For example, the back may have a different duration threshold than the arms.

The module can be configured to store low-resolution, blurred images of the poses triggered by pose changes or on fixed time intervals. The low-resolution images are readily blurred so as to preserve patient privacy.

### 4 PATENT CITATIONS

US20120277637 Filing: Nov. 17, 2010 Publication: Nov. 1, 2012 Applicant: Alireza Vahdatpour Title: Method And System For Monitoring Pressure Areas On A Supported Body
US20120323501 Filing: May 18, 2012 Publication: Dec. 20, 2012 Applicant: The Regents Of The University Of California Title: Fabric-based pressure sensor arrays and methods for data analysis
U.S. Pat. No. 8,672,842 Filing: Aug. 23, 2011 Publication: Mar. 18, 2014 Applicant: Evacusled Inc. Title: Smart mattress
WO2013016132A2 Filing-Jul. 19, 2012 Publication: Jan. 31, 2013 Applicant: Tci3-Pressure Applications Llc Title: Systems and methods for monitoring and providing therapeutic support for a user
U.S. Pat. No. 8,752,222 Filing: Oct. 13, 2009 Publication: Jun. 17, 2014 Applicant: Papaioannou; George Title: Adaptable surface for use in beds and chairs to reduce occurrence of pressure ulcers
U.S. Pat. No. 8,675,059 Filing: Jul. 29, 2010 Publication: Mar. 18, 2014 Applicant: Johnson; Steve Gail et al Title: System and method for using a video monitoring system to prevent and manage decubitus ulcers in patients
U.S. Pat. No. 9,041,810 B2 Filing: Jul. 1, 2014 Publication: May 26, 2015 Applicant: Stephen Ecker et al Title: System and method for predicting patient falls

1. A method for monitoring a user for potential pressure ulcers, the steps of the method comprising:
Form an image in low to high lighting conditions of the user.
Determine the areas under pressure from the image.
Track the areas under pressure by continually taking images and process them in this fashion.
Generate an alert if any area is under pressure longer than a specified duration over a time period.

2. The method according to claim 1, wherein the patient is in a bed.

3. The method according to claim 1, wherein the patient is in a chair.

4. The method according to claim 1, wherein the patient is in a wheelchair.

5. A method for determining a user's position, the steps of the method comprising:
Form an image in low to high lighting conditions of the user.
Calculate and quantify the users current positioning.

6. The method according to claim 5, wherein the patient is in a bed.

7. The method according to claim 5, wherein the patient is in a chair.

8. The method according to claim 5, wherein the patient is in a wheelchair.

9. A method for determining a user's position and determine potential areas for pressure ulcers, the steps of the method comprising:
Form an image in low to high lighting conditions of the user.
Calculate and quantify the users current positioning.
Calculate potential areas of pressure ulcers.

10. The method according to claim 9, wherein the patient is in a bed.

11. The method according to claim 9, wherein the patient is in a chair.

12. The method according to claim 9, wherein the patient is in a wheelchair.

13. The use of a device that can form images in low to high lighting conditions, the method comprising:
Mounting the device in a position to view the patient
Collecting images to be analyzed as specified in claims 1-12
Sending analysis results wirelessly or wired to a central processing unit for viewing and alerting

14. The method according to claim 13, wherein the device is mounted to a wall.

15. The method according to claim 13, wherein the device is mounted to a ceiling.

16. The method according to claim 13, wherein the device is mounted to a wheelchair.

17. The method according to claim 13, wherein the device is mounted to a chair.

18. The method according to claim 13, wherein the device is mounted to a mobile, but stationary object.

19. The method according to claim 13, wherein the device is mounted to a stationary object.
